(19) United States
(12) Patent Application Publication
(10) Pub. No.: US 2019/0340595 A1
(43) Pub. Date: Nov. 7, 2019

(54) METHOD AND SYSTEM FOR FACILITATING INSTALLMENT-BASED PAYMENT CARD TRANSACTIONS

(71) Applicant: MASTERCARD INTERNATIONAL INCORPORATED, Purchase, NY (US)

(72) Inventor: Vidit BHARGAVA, Pune (IN)

(21) Appl. No.: 16/400,558

(22) Filed: May 1, 2019

(30) Foreign Application Priority Data
May 2, 2018 (SG) 10201803691R

(51) Int. Cl. G06Q 20/24; G06Q 20/34

(52) U.S. Cl. CPC G06Q 20/24; G06Q 20/34

(57) ABSTRACT

Methods and server systems for facilitating installment-based payment transactions are provided. A conversational agent is provided on an interaction channel for assisting users with selection of installment payment options for respective payment card transactions. Information related to an intended purchase is extracted by the conversational agent during an ongoing interaction with a user. An estimate of a transaction value associated with the intended purchase is determined based on the extracted information. At least one installment payment option is identified based at least in part on the estimate of the transaction value. A processing of payment transaction is facilitated subsequent to execution of the intended purchase by the user. The payment transaction is processed based on a selection of an installment payment option by the user.

### TECHNICAL FIELD

The present disclosure relates to payment card transactions, and more particularly, to a method and system for facilitating installment-based payment card transactions.

### BACKGROUND

Nowadays, most users use several banking cards, such as credit cards, debit cards, prepaid cards, etc. for performing financial transactions. The various banking cards are referred to herein as payment cards. The payment cards may be used for financial transactions, such as for making payment at a point-of-sale (POS) terminal, for making an online purchase transaction, or even for withdrawing currency from an Automated Teller Machine (ATM).

Typically, most issuers of the payment cards extend several installment payment options to their respective users. A user may opt to pay for a high value transaction in installments instead of making a lump sum payment for the entire billed amount. The option to pay in installments reduces or spreads the burden of payment for the high value transaction, and, in some cases, may even enable the user to engage in the high value purchase transaction itself

However, currently, selecting an appropriate installment payment option from among several options offered by an issuer of a payment card is a hassle for the user. The complexity of selection of the appropriate installment payment option increases manifold, when the user has several payment cards at the user's disposal.

Furthermore, the user may have several queries related to the offers. In an illustrative example, the user may wish to know how much money would be saved if the user chooses a particular installment payment option offered by an issuer as opposed to an installment payment option with no fees offered by another issuer. The user may also need assistance in selecting an installment payment option of interest on an ongoing purchase transaction.

Accordingly, there is a need to assist users in selecting suitable installment payment options from among several installment payment options available to them. It would also be advantageous to assist the users with their queries and facilitate processing of the payment transaction using the selected installment payment option.

### BRIEF SUMMARY

Various embodiments of the present disclosure provide systems, methods, electronic devices and computer program products to facilitate installment-based payment card transactions.

In an embodiment, a method for facilitating installment-based payment transaction is disclosed. The method includes receiving a first input by a conversational agent from a user. The first input is received by the conversational agent during an ongoing interaction with the user. The first input corresponds to a query for installment payment options for an intended purchase of a product by the user. The method includes extracting from the first input, by the conversational agent, information related to the product to be purchased, a location associated with the intended purchase and one or more payment cards capable of being used by the user for the intended purchase. The method includes identifying at least one installment payment option from among a plurality of installment payment options based on the extracted information. The method includes provisioning, by the conversational agent, the at least one installment payment option to the user during the ongoing interaction. The method includes receiving, by the conversational agent, a second input corresponding to a user preference for installment payments. The second input is configured to facilitate a selection of an installment payment option from among the at least one installment payment option. Further, the method includes facilitating processing of a payment transaction subsequent to execution of the intended purchase by the user. The processing of the payment transaction is facilitated based on the selection of the installment payment option by the user.

In another embodiment, a server system configured to facilitate an installment-based payment transaction is disclosed. The server system includes a memory comprising stored instructions, and at least one processor configured to execute the stored instructions to cause the server system to provide a conversational agent on an interaction channel for assisting users with selection of installment payment options for respective payment card transactions. The server system is caused to receive information related to an intended purchase by a user from the conversational agent. The information is extracted by the conversational agent from an ongoing interaction with the user on the interaction channel. The server system is caused to determine an estimate of a transaction value associated with the intended purchase based on the extracted information. The server system is caused to identify at least one installment payment option from among a plurality of installment payment options based at least in part on the estimate of the transaction value. The server system is caused to a provision the at least one installment payment option to the user during the ongoing interaction with the conversational agent. Further, the server system is caused to facilitate processing of a payment transaction subsequent to execution of the intended purchase by the user. The processing of the payment transaction is facilitated based on a selection of an installment payment option by the user from among the at least one installment payment option.

In an embodiment, a method for facilitating installment-based payment transaction is disclosed. The method includes receiving, by a server system, a payment transaction from an acquirer account for processing. The payment transaction includes a transaction amount associated with a purchase executed by a user. The method includes authenticating, by the server system, the user based on information associated with the payment transaction. Subsequent to successful authentication, the method includes comparing, by the server system, the transaction amount of the payment transaction with a stored estimate of the transaction value. If the transaction amount substantially matches the estimate of the transaction value, the method includes retrieving by the server system a stored selection of an installment payment option corresponding to the estimate of the transaction value. Further, the method includes facilitating, by the server system, processing of the payment transaction between an issuer account associated with a payment card of the user and the acquirer account based on the stored selection of the installment payment option.

### BRIEF DESCRIPTION OF THE DRAWINGS

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 represents a sequence flow diagram for illustrating a server system facilitating user selection of an installment payment option, in accordance with an example embodiment of the present disclosure;

FIG. 3 depicts an example interaction between a conversational agent and a user seeking assistance on installment payment options, in accordance with an example embodiment of the present disclosure;

FIG. 4 shows a table for illustrating an example determination of an estimate of a transaction value, in accordance with an example embodiment of the present disclosure;

FIG. 5 shows a table for illustrating identification of installment payment options for the user, in accordance with an example embodiment of the present disclosure;

FIG. 6 shows a table for illustrating example loan configurations generated by the server system, in accordance with an example embodiment of the present disclosure;

FIG. 7A represents a sequence flow diagram for illustrating processing of the payment transaction based on the selected installment payment option, in accordance with an example embodiment of the present disclosure;

FIG. 7B shows a representation of an example message provisioned to the user subsequent to successful processing of the payment transaction as per the user selected installment payment option, in accordance with an example embodiment of the present disclosure;

FIG. 8 illustrates a flow diagram of a method for facilitating installment-based payment transaction, in accordance with an example embodiment of the present disclosure;

FIG. 9 illustrates a flow diagram of a method for facilitating installment-based payment transaction, in accordance with another example embodiment of the present disclosure;

FIG. 10 is a simplified block diagram of a server system used for facilitating installment-based payment transactions, in accordance with an example embodiment of the present disclosure;

FIG. 11 is a simplified block diagram of a POS terminal used for payment transaction, in accordance with an example embodiment of the present disclosure;

FIG. 12 is a simplified block diagram of an issuer server for facilitating payment transaction using installment payment option, in accordance with one embodiment of the present disclosure;

FIG. 13 is a simplified block diagram of an acquirer server used for payment transaction using installment payment option, in accordance with one embodiment of the present disclosure;

FIG. 14 is a simplified block diagram of a payment server used for facilitating payment transaction using installment payment option, in accordance with one embodiment of the present disclosure; and

FIG. 15 shows simplified block diagram of a user device capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refers to a financial account that is used to fund the financial transaction (interchangeably referred to as “payment transaction”). Examples of the payment account include, but is not limited to a savings account, a credit account, a checking account and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by PayPal®, and the like.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

The term “payment card”, used throughout the description, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively, or additionally, the payment card may be embodied in form of data stored in a user device, where the data is associated with payment account such that the data can be used to process the financial transaction between the payment account and a merchant's financial account.

### Overview

Users typically use a variety of banking cards, such as credit cards, debit cards, etc. to perform financial transactions. Some examples of financial transactions include making payments at point-of-sale (POS) terminals in merchant sites, making online payments using payment gateways associated with enterprise websites, withdrawing currency from automated teller machine (ATM) kiosks, and the like.

In many scenarios, the users may wish to opt for an installment payment option for executing a payment transaction. Currently, selecting a suitable installment payment option from among a plurality of installment payment options offered by several issuers of payment cards is cumbersome for the user. Moreover, currently there is no mechanism to address user queries related to the installment payment options and assist the users in engaging in payment transactions with installment payment options.

Various example embodiments of the present disclosure provide methods, systems and computer program products for overcoming the above drawbacks and providing additional advantages. More specifically, various embodiments as disclosed herein facilitate installment-based payment card transactions. The term ‘installment-based payment card transaction’ as used hereinafter refers to a payment card transaction executed as per installment payment option previously selected by the user. The techniques disclosed herein provide the user with the desired assistance in selecting an appropriate installment payment option from among several installment payment options. Moreover, user queries are addressed and the payment transaction is executed with the selected installment payment option in a hassle-free and convenient manner for the user.

In one embodiment, a server system associated with a payment card system interchange network (hereinafter referred to as payment network), such as the MasterCard® interchange network provides a conversational agent on an interaction channel. The term ‘conversational agent’ as used herein may refer to a human agent, or a machine agent such as a chatbot or an interactive voice response (IVR) system. Accordingly, the conversational chat may be configured to use textual chat medium (in case of a textual chat interaction) or a voice medium to interact with users on interaction channels. The term ‘interaction channel’ as used herein may refer to a Web interaction channel, such as a website, an interactive voice response (IVR) channel, a chat channel, and the like. In one embodiment, the interaction channel may correspond to a website associated with a payment network entity, such as for example entity configured to facilitate payment card transactions. In another embodiment, the website may correspond to a website of an issuer of a payment card associated with the user. In yet another embodiment, the website may correspond to a merchant website offering products, services and/or information for sale to prospective users.

The conversational agent is configured to engage in an interaction, for example a textual chat interaction or a voice chat interaction, with the user on the interaction channel to assist the user in selecting an appropriate installment payment option for a purchase that the user intends to engage in, in near future. In one embodiment, the conversational agent is configured to interact with the user and use natural language processing and artificial intelligence logic to extract information, such as a type of a product to be purchased, a brand name and brand model associated with the product to be purchased, a location associated with the intended purchase and one or more payment cards capable of being used by the user for the intended purchase. The conversational agent is configured to provide the extracted information to the server system associated with the payment network.

In one embodiment, the server system is configured to determine an estimate of a transaction value associated with the intended purchase based on the extracted information. To that effect, in one embodiment, the server system is configured to retrieve sale offer values for the product to be purchased from one or more merchants in the location associated with the intended purchase. For example, if the user intends to purchase a phone model ‘X’ offered by brand ‘Y’, then the server system may retrieve all sale offer values for such a model being offered by various merchants in the state or the city the user intends to make the purchase. In one embodiment, the server system may be configured to select the highest sale offer value from among the sale offer values as the estimate of the transaction value for the intended purchase.

Further, for the estimated value of transaction, the server system is configured to retrieve installment payment options offered by issuers of one or more payment cards that the user may use for the intended purchase. In one embodiment, the server system may be configured to retrieve account ranges for the various payment cards associated with the user. Further, different installment payment options available for the given estimate of transaction value may be retrieved and at least one installment payment option may be identified to be relevant to the user based on the estimate of the transaction value and predicted user preference. The predicted user preference may correspond to at least one of a preference for low annual percentage rate (APR), a preference for long-term installment plan (i.e. a plan with maximum installment tenure), a preference for low overall payment and a preference for low processing fees.

The server system may further be configured to cause provisioning of the at least one installment payment option to the user during the ongoing interaction with the conversational agent. More specifically, the server system may be configured to provision the installment payment options to the conversational agent, who may then relay the installment payment options to the user during the ongoing interaction.

An installment payment option may be selected from among the offered installment payment options either directly by the user or through stating a preference. Subsequent to the selection and/or confirmation of the installment payment option, in one example embodiment, the server system is configured to store the estimate of the transaction value and the installment payment option.

Subsequently, when the user executes the intended purchase for example at a POS terminal or as an online transaction, the acquirer account associated with the merchant is configured to provide the payment transaction to the server system for processing the payment transaction. The server system is configured to authenticate the user from the information associated with the payment transaction and subsequent to successful authentication, compare the transaction amount with the estimate of the transaction value. If the transaction amount substantially matches the estimate of the transaction value, then the server system is configured to facilitate processing of the payment transaction. More specifically, the server system is configured to intimate the issuer of the payment card (i.e. the payment card used by the user for the purchase) of the selection of the installment payment option. The issuer may then process the payment transaction as per the installment payment option selected by the user. In some embodiments, a message may be provisioned to the acquirer account and/or the user indicating the successful processing of the payment transaction as per the user selected installment payment option.

As explained above, the user queries are addressed by the conversational agent and user is assisted in selecting an appropriate installment payment option by the conversational agent. Moreover, the payment transaction is processed as per the selection of the installment payment option by the user. As a result, the entire process of selection of the appropriate installment payment option and the subsequent processing of the payment transaction is rendered convenient and hassle-free for the user.

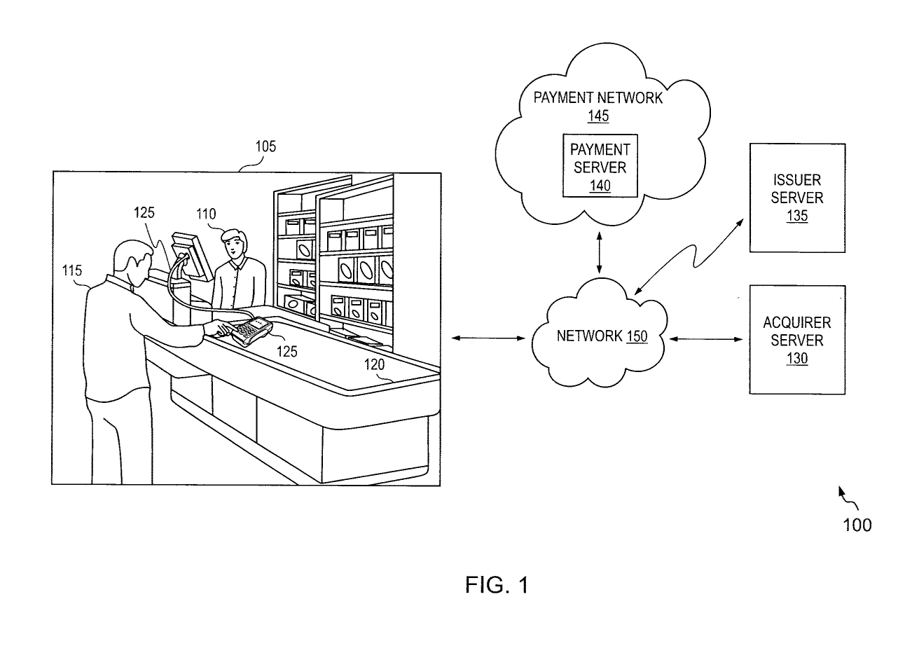

FIG. 1 illustrates an example representation of an environment 100, in which at least some example embodiments of the present disclosure can be implemented. In the illustrated embodiment, a facility 105 is shown. Examples of the facility 105 may include any retail shop, supermarket or establishment, a government and/or private agency, a ticket counter, or any such place or establishment where users perform financial transactions in exchange of any goods and/or services or any transaction that requires financial transaction between the user and the facility 105.

As can be seen from the environment 100, a customer 115 (hereinafter referred to as a user 115) is standing near a payment desk 120 to make a financial transaction to a merchant 110 for a product purchased by the user 115 from the facility 105. The facility 105 also includes a merchant interface 125. Examples of the merchant interface 125 include a point of sale device or a point of sale terminal 125 (hereinafter interchangeably referred to as a ‘POS terminal 125’) placed on the payment desk 120 using which the payment transaction can be initiated. In various embodiments, the merchant interface 125 can be a merchant telephone, merchant computer system, and the like.

Alternatively, or additionally, the merchant interface 125 can also be an online merchant interface such as a merchant Website, a mobile or desktop application or a third-party Website or application using which the user 115 may purchase goods or service from a remote location or with in-store presence.

As shown in the environment 100, the user 115 is entering a personal identification number (PIN) using the POS terminal 125. Alternatively, in the embodiment of the merchant interface being the online merchant interface, the user 115 may enter payment card details using an electronic device, such as for example his personal computer or a mobile phone or any other electronic device while purchasing a product online from the merchant Website. Some non-exhaustive examples of payment card details entered using the electronic device include payment card number, date of expiry, Card Verification Value (CVV) details, and the like.

In anon-limiting example, authorization of the user's bank account with sufficient funds for making a transaction of ‘X’ amount to complete the payment transaction and application of the installment payment option to the payment transaction is performed by a combination of an acquirer server 130, an issuer server 135 and a payment server 140. In one embodiment, the payment server 140 is associated with a payment network 145. The payment network 145 may be used by payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.).

The issuer server 135 is associated with a financial institution normally called as an “issuer bank” or “issuing bank” or simply “issuer”, in which the user 115 may have an account, which issues a payment card, such as a credit card or a debit card. The user 115, being the cardholder, can use the payment card details associated with the payment card to tender payment for a purchase from the merchant 110.

To accept payment, the merchant 110 must normally establish an account with a financial institution that is part of the financial payment system. This financial institution is usually called the “merchant bank” or the “acquiring bank” or “acquirer bank” or simply “acquirer”. The acquirer server 130 is associated with the acquirer bank.

Using the payment network 145, the computers of the acquirer/the acquirer server 130 or the merchant processor will communicate with the computers of the issuer/the issuer server 135 to determine whether the user's account is in good standing and whether the purchase is covered by the user's available account balance. Based on these determinations, authorization of the payment transaction is declined or accepted. When the authorization is accepted, the available balance of user's account is decreased. Normally, a charge is not posted immediately to a user's account because bankcard associations, such as Mastercard International Incorporated®, have promulgated rules that do not allow a merchant to charge, or “capture,” a transaction until goods are shipped or services are delivered. When the merchant 110 ships or delivers the goods or services, the merchant 110 captures the transaction by, for example, appropriate data entry procedures on the POS terminal 125. If the user 115 cancels a transaction before it is captured, a “void” is generated. If the user 115 returns goods after the transaction has been captured, a “credit” is generated.

After a transaction is captured, the transaction is settled between the merchant 110, the acquirer and the issuer. Settlement refers to the transfer of financial data or funds between the merchant's account, the acquirer, and the issuer, related to the transaction. Usually, transactions are captured and accumulated into a “batch”, which is settled as a group.

A user device (e.g., a mobile phone or desktop computer of the user 115), the merchant device (e.g., the POS terminal 125) associated with the merchant interface, the issuer server 135, the acquirer server 130 and the payment server 140 communicate with one another using a network 150. Examples of the network 150 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 150 may be or include the Internet, intranets, extranets, microwave networks, satellite communications, cellular systems, personal communication services (“PCS”), infrared communications, global area networks, or other suitable networks, etc., or any combination of two or more such networks.

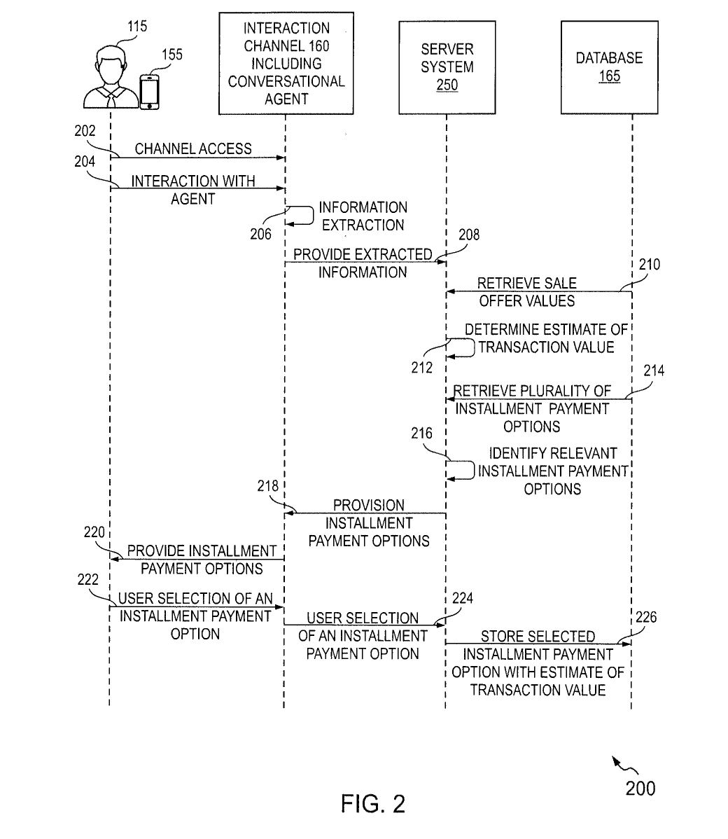

Various embodiments of the present disclosure provide mechanisms such that when the user 115 initiates a regular payment transaction (such as for example, by swiping a payment card in the POS terminal 125 or, in case of an interaction channel, provide payment card details) to make a purchase, a pre-selected installment payment option is applied to the payment transaction and the payment transaction is processed as per the selected installment payment option. The user 115 is assisted in making the selection of the appropriate installment payment option by a conversational agent. The user may seek assistance from the conversational agent at any time prior to the intended purchase. Accordingly, the user is spared the effort of comparing various installment payment options offered by several payment cards associated with the user. Moreover, the user preference, such as low Annual Percentage Rate (APR) or low processing fees or long-term installment plan is taken into account for providing the user 115 with the options of installment payment from among the several installment payment options. Further, the user may ask queries such as for example, which option if selected, results in the least cost or how does option 1 compare with option 3 given all parameters are the same, and the like, to the conversational agent and thereafter choose an installment payment option most suited to his or her needs. A sequence flow diagram illustrating assistance provided to the user by a server system to facilitate selection of an installment payment option is explained with reference to FIG. 2.

FIG. 2 represents a sequence flow diagram 200 for illustrating a server system 250 facilitating user selection of an installment payment option, in accordance with an example embodiment of the present disclosure. The terms ‘server system’, or ‘server’ or ‘system’ are used interchangeably hereinafter. In at least one example embodiment, the term ‘server system 250′ as used herein corresponds to the payment server 140 (shown in FIG. 1). In some embodiments, the server system 250 may correspond to the issuer server 135 or the acquirer server 130 explained with reference to FIG. 1. In some example scenarios, the issuer server 135, the acquirer server 130 and the payment server 140 can be a single entity, or any two of these servers may be a single entity, configuring the server system 250.

At 202, the user 115 using an electronic device 155 accesses an interaction channel 160 to seek assistance on selection of an installment payment option for an intended purchase. The interaction channel may correspond to a Web interaction channel, i.e. a website. In one embodiment, the website 160 corresponds to a website associated with a payment network entity configured to facilitate payment transactions, such as for example Mastercard®. In another embodiment, the website 160 corresponds to a website of an issuer of a payment card associated with the user. In yet another embodiment, the website corresponds to a merchant website offering products, services and/or information for sale to prospective users. In some embodiments, the interaction channel may correspond to an IVR channel.

In at least some embodiments, the server system 250 is configured to extend assistance to users visiting the interaction channel 160 in form of services of a conversational agent. For example, the conversational agent on the website may correspond to a chat agent configured to engage in a textual chat interaction with users to provide assistance to the users. In another illustrative example, the conversational agent on the IVR channel configured to engage in a voice chat interaction with users to provide assistance to the users. The users can interact with the conversational agent on the interaction channel 160 to select an appropriate installment payment option for an intended purchase. To provide services of a conversational agent, in at least some example embodiments, the server system 250 may be configured to be in operative communication with the server associated with the interaction channel 160. In an illustrative example, the server system 250 may be configured to be in operative communication with a Web server hosting the website. The web pages of the website may be configured to display a widget or an icon displaying text like ‘Need Assistance, Click Here!’ or ‘Have questions? Chat with our agent’. The user selection of such a widget or icon on the website may trigger an application programming interface (API) call to retrieve virtual agent logic provided by the server system 250. The virtual agent logic is configured to simulate a human agent. To that effect, the virtual agent logic may be associated with machine learning models trained to interpret natural language user input and provide appropriate response in natural language form.

At 204, the user 115 engages in an interaction with the conversational agent provided on the interaction channel 160. The user may provide inputs, such as a first input related to an intended purchase of a product to the conversational agent and may seek help for selecting an appropriate installment payment option for the intended purchase.

At 206, the conversational agent uses natural language processing and artificial intelligence logic to extract information, such as a type of a product to be purchased, a brand name and brand model associated with the product to be purchased, a location associated with the intended purchase and/or one or more payment cards that the user has at the user's disposal and which can be used for executing the payment transaction.

At 208, the conversational agent provides the extracted information to the server system 250.

At 210, the server system 250 identifies a product to be purchased from the extracted information and queries a database 165 associated with the server system 250 to retrieve sale offer values for the product to be purchased from one or more merchants in the location associated with the intended purchase. For example, if the user intends to purchase a particular brand of smartphone, then the server system 250 retrieves sale offer values, or in other words, prices of smartphones as offered by various merchants in the location that the user intends to make the purchase. The sale offer values are retrieved from the database 165 associated with the server system 250.

At 212, the server system 250 determines an estimate of a transaction value associated with the intended purchase. For example, the server system 250 may select a sale offer value (for example, the highest sale offer value or the average sale offer value) as the estimate of the transaction value for the intended purchase.

At 214, the server system 250 queries the database 165 to retrieve account ranges for the various payment cards associated with the user. Further, a plurality of installment payment options available for the given estimate of transaction value may be retrieved.

At 216, the server system 250 is configured to identify at least one installment payment option to be relevant to the user based on the estimate of the transaction value and predicted user preference. The predicted user preference may correspond to at least one of a preference for low annual percentage rate (APR), a preference for maximum installment tenure, a preference for low overall payment and a preference for low processing fees. More specifically, the server system 250 may predict that the user may prefer low overall payment or low processing fees or maximum installment tenure. Based on such predicted preference, the server system 250 may identify installment payment options for the user. It is noted that, in some embodiments, the prediction of user preference may be precluded and the user may be provisioned relevant installment payment options. The user may then provide an input, for example, a second input indicative of the user preference. For example, the user may specify that the user prefers low overall payment or low APR and accordingly, an installment payment option associated with such a user preference may be selected for the intended purchase.

At 218, the server system 250 provisions the one or more installment payment options to the conversational agent on the interaction channel 160.

At 220, the conversational agent provisions the installment payment options to the user during the ongoing interaction with the user on the interaction channel 160.

At 222, the user provides a selection of an installment payment option from among the one or more installment payment options to the conversational agent. In some example scenarios, the user may ask queries related to the offered installment options to the conversational agent and select an installment payment option only upon being satisfied of the suitability of the installment payment option to his or her needs.

At 224, the conversational agent provides the installment payment option to the server system 250.

At 226, the server system 250 is configured to store the user selection of the installment payment option along with the estimate of the transaction value for the intended purchase in the database 165.

In future, when the user executes the intended purchase at a merchant location (for example, at the facility 105 or using the merchant Website), the merchant's account or the acquirer provisions the payment card information to the server system 250 for authentication. The server system 250 performs user authentication for payment card information provided by the user. Subsequent to successful authentication, the server system 250 compares the transaction amount associated with the payment transaction with the stored estimate of the transaction value. If the stored estimate of the transaction value substantially matches the transaction amount, then the server system 250 is configured to retrieve the selected installment payment option from the database 165. The server system 250 is further configured to provide the payment transaction information to the issuer server 135 to perform user authorization to facilitate the processing of the payment transaction. The server system 250 is also configured to provide the user selected installment payment option to the issuer server 135. The issuer server 135 is configured to perform the user authorization and post successful authorization, the issuer server 135 is configured to process the payment based on the selected installment payment option. In some embodiments, the user may be intimated of the successful processing of the payment transaction based on the selected installment payment option.

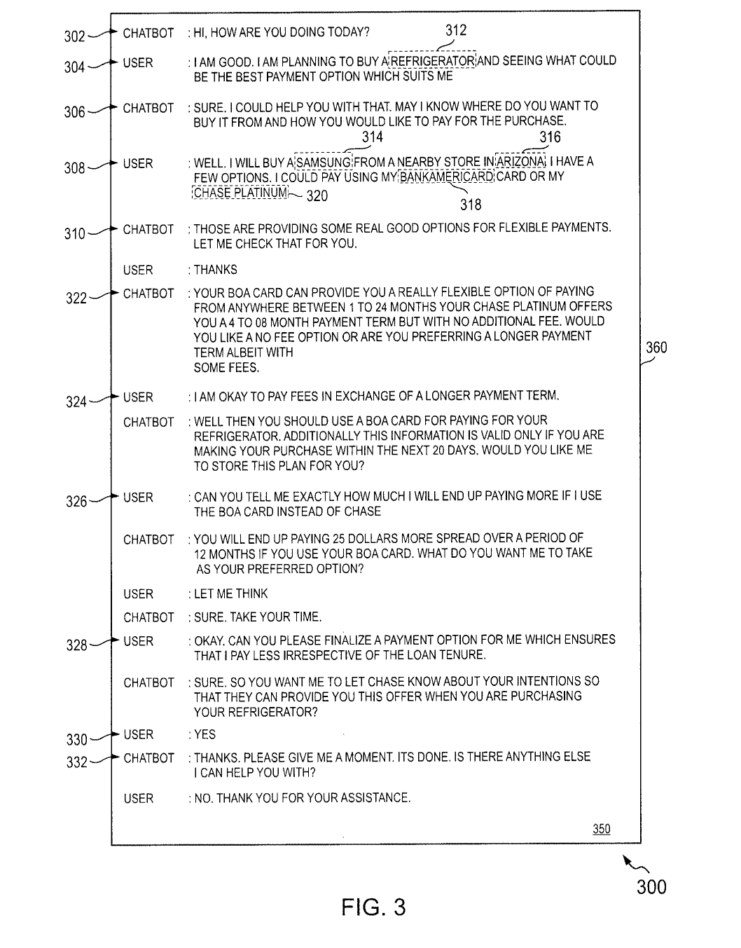

The facilitation of installment-based payment card transactions is further explained using an illustrative example with reference to FIGS. 3 to 8.

FIG. 3 depicts a representation 300 of an example interaction 350 between a conversational agent and a user seeking assistance on installment payment options, in accordance with an example embodiment of the present disclosure.

In an example scenario, the user may click on a widget or an icon displayed on the website to seek for agent assistance. Subsequent to providing a touch or a click input on the widget/icon, a chat console, such as the example chat console 360 shown in FIG. 3 may be displayed to the user on the display screen of the user's electronic device.

The conversational inputs by the conversational agent are exemplarily depicted to be tagged with the label ‘CHATBOT’ in the interaction 350, whereas the conversational inputs by the user are exemplarily depicted to be tagged with the label ‘USER’. As explained with reference to FIG. 2, a user may access an interaction channel to seek assistance on installment payment options for making an intended purchase using a payment card. The interaction channel may correspond to a website of a payment network entity (such as for example, Mastercard® website), a website of a banking institution, an e-commerce website or the like. Further, as explained with reference to FIG. 2, the server system 250 is configured to provision conversational agent, such as a chatbot on the website or the IVR system, to assist the prospective users with queries related to installment payment options.

The interaction 350 is depicted to have been initiated by the conversational agent (inputs shown using label ‘CHATBOT’) at 302 by a greeting.

At 304, the user provides a, first input, i.e. an input specifying her requirement of identifying a suitable installment payment option for purchase of a refrigerator.

At 306, the conversational agent is depicted to have inquired about additional information related to the purchase, such as where the user intends to make the purchase and which payment cards are at the user's disposal to engage in a financial transaction.

At 308, the user provides the requested information in form of brand ‘SAMSUNG’, location of purchase as ‘ARIZONA’ and payment cards in form of ‘BANKAMERICARD’ and ‘Chase Platinum’.

It is noted that the inputs provided at 304 and 308 may together or individually constitute the first input. More specifically, the first input may correspond to a query for installment payment options for an intended purchase of a product by the user along with information related to the intended purchase of the product, such as a type of the product (for example, a refrigerator), a brand name, a location of purchase and information related to one or more payment cards that the user intends to use for the purchase of the product.

At 310, the conversational agent is depicted to have requested for some time to identify the best installment payment options for the user given the user-specified requirements.

As explained with reference to FIG. 2, the conversational agent is configured to use natural language processing (NLP) and artificial intelligence (AI) logic to engage in an interaction with the user and moreover, extract information from the interaction that may be used to determine the installment payment options most suitable to the user.

In at least one embodiment, the extracted information from the interaction 350 includes information related to the product to be purchased, i.e. the REFRIGERATOR, the brand of the product, i.e. ‘SAMSUNG’, the location of purchase, i.e. ‘ARIZONA’ and the payment cards associated with the user, i.e. ‘BANK AMERICARD’ and ‘CHASE PLATINUM’, as depicted by dotted blocks 312, 314, 316, 318 and 320 in FIG. 3, respectively.

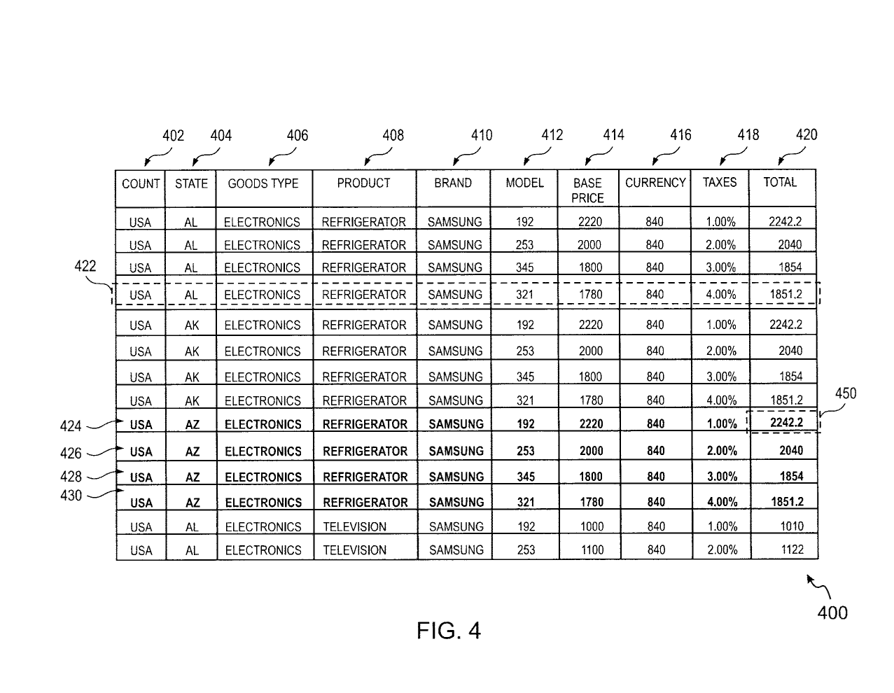

As explained with reference to FIG. 2, the conversational agent is configured to provision the information to the server system 250. The server system 250 is configured to receive the information and determine an estimate of a transaction value associated with the intended purchase. The determination of the estimate of the transaction value is explained with reference to an illustrative example in FIG. 4.

Referring now to FIG. 4, a table 400 is shown for illustrating an example determination of an estimate of a transaction value, in accordance with an example embodiment of the present disclosure.

As explained with reference to FIG. 3, the conversational agent is configured to use NLP and AI logic to extract information such as a type of a product intended to be purchased, a brand associated with the product, a location of the purchase and payment cards that are at the user's disposal for executing the intended purchase. Accordingly, information, such as information shown in dotted blocks 312-320 in FIG. 3, is extracted from the interaction between the conversational agent and the user.

In at least one example embodiment, the server system 250 is configured to query a database, such as the database 165 shown in FIG. 2, to retrieve sale offer values (i.e. prices) for the product to be purchased from one or more merchants in a plurality of geographical regions. The retrieved information is extracted in a tabular form as depicted by the table 400. However, it is noted that information related to sale offer values may be retrieved in any form, such as comma separated value (CSV) form, a tab form and the like, and may not be limited to the tabular form depicted in FIG. 4.

The table 400 depicts a plurality of columns such as columns 402, 404, 406, 408, 410, 412, 414, 416, 418 and 420 associated with labels ‘COUNTRY’, ‘STATE’, ‘GOODS TYPE’, ‘PRODUCT’, ‘BRAND’, ‘MODEL’, ‘BASE PRICE’, CURRENCY’, ‘TAXES’ AND ‘TOTAL’. Each column is depicted to include several entries corresponding to the respective labels. For example, the row 422 is depicted to include entries: ‘US’ in column 402 for country, ‘AL’ (i.e. Alabama) in column 404 for state, ‘ELECTRONICS’ in column 406 for goods type, ‘REFRIGERATOR’ in column 408 for product, ‘SAMSUNG’ in column 410 for brand, ‘321’ in column 412 for model, ‘1780’ in column 414 for base price, ‘840’ in column 416 for currency, ‘4.00%’ in column 418 for taxes and ‘1851.2’ in column 420 for total (i.e. total price). More specifically, the entries in the row 422 provide the sale offer value, i.e. 1851.2 US Dollars (USD), for a Samsung® refrigerator model 321 offered for sale by a merchant in Alabama.

The server system 250 is configured to compare the extracted information with the entries in the table 400 to identify sale offer values for Samsung® refrigerators offered by merchants in location of purchase specified by the user, i.e. ‘ARIZONA’. Accordingly, rows 424, 426, 428 and 430 are identified as relevant to the user as they include information related to sale offer values for Samsung® refrigerators offered by merchants in state of Arizona.

In at least one example embodiment, the server system 250 may be configured to select the highest sale offer value, i.e. value 2242.2 (or 2242 for the purposes of description) shown in dotted block 450 as the estimate of the transaction value. The highest sale offer value may be chosen as the estimate of the transaction value as the installment payment options that are applicable for a higher transaction value are more likely to be applicable to even a lower transaction value, however, an installment payment option applicable for a lower transaction value may not be necessarily be applicable to a higher transaction value. Hence, in at least some embodiments, the highest sale offer value may be selected as the estimate of the transaction value. However, it is noted that in some embodiments, the server system 250 may compute an average value or a weighted average of the relevant sale offer values to determine the estimate of the transaction value.

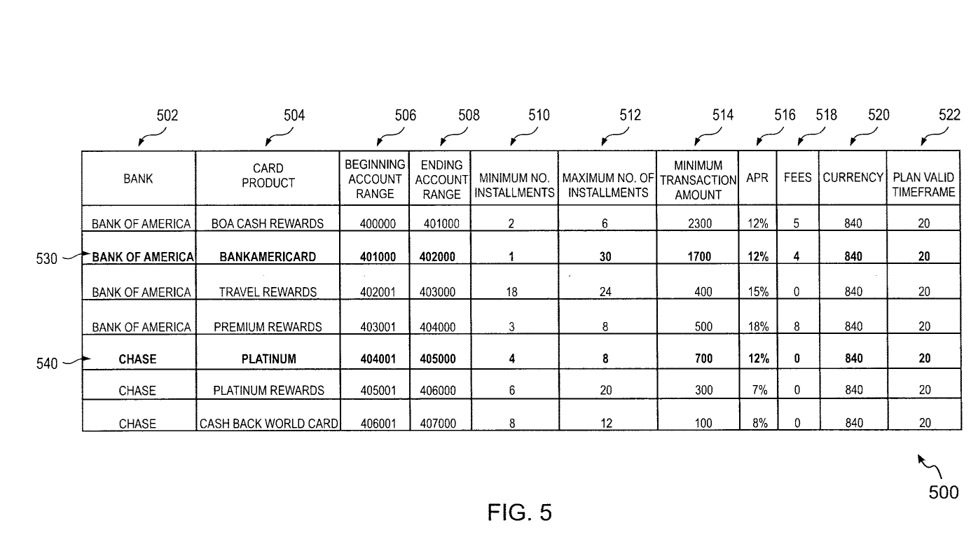

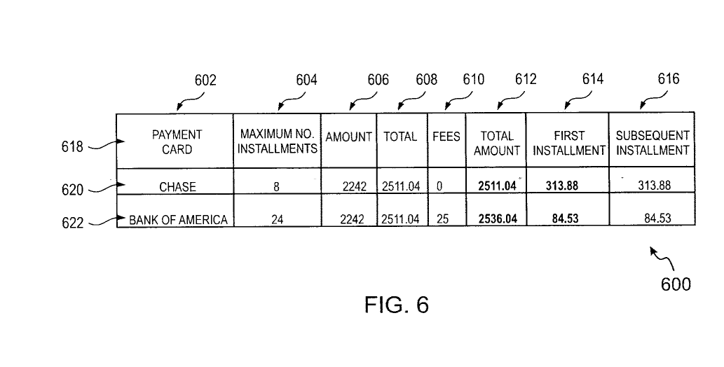

In at least one example embodiment, the server system 250 may be configured to retrieve installment payment options from the database and identify relevant options for the user based on the estimate of the transaction value and the payment cards at the user's disposal. The identification of the relevant installment payment options for the user is further explained with reference to FIGS. 5 and 6.

Referring now to FIG. 5, a table 500 is shown for illustrating identification of installment payment options for the user, in accordance with an example embodiment of the present disclosure.

As explained with reference to FIG. 3, the conversational agent is configured to use NLP and AI logic to extract information such as a type of a product intended to be purchased, a brand associated with the product, a location of the purchase and payment cards associated with the user. Accordingly, information, such as information shown in dotted blocks 312-320 in FIG. 3, is extracted from the interaction between the conversational agent and the user.

In at least one example embodiment, the server system 250 is configured to query a database to retrieve information related to payment cards specified by the user as well as plurality of installment payment options associated with the respective cards. For example, as the user specified using one of the ‘Bankamericard’ and ‘Chase Platinum’ payment cards for the intended purchase, the information related to card products offered by the issuers ‘Bank of America®’ and ‘Chase®’ are retrieved along with the installment payment options associated with the respective card products. The retrieved information is extracted in a tabular form as depicted by the table 500. However, it is noted that information related to installment payment options may be retrieved in any form, such as comma separated value (CSV) form, a tab form and the like, and may not be limited to the tabular form depicted in FIG. 5.

The table 500 depicts a plurality of columns such as columns 502, 504, 506, 508, 510, 512, 514, 516, 518, 520 and 522 associated with labels ‘BANK’, ‘CARD PRODUCT’, ‘BEGINNING ACCOUNT RANGE’, ‘ENDING ACCOUNT RANGE’, ‘MINIMUM NO. OF INSTALLMENTS’, ‘MAXIMUM NO. OF INSTALLMENTS’, ‘MINIMUM TRANSACTION AMOUNT’, ‘APR’, ‘FEES’, ‘CURRENCY’ and ‘PLAN VALID TIMEFRAME’. Each column is depicted to include several entries corresponding to the respective labels.

In some embodiments, the account ranges (for example, values included in the entries in columns 506 and 508, i.e. the beginning account range and the ending account range, respectively) may be initially retrieved from the database by the server system 250. Thereafter, information such as the APR, fees, maximum and minimum number of installments, and the like may be retrieved corresponding to each payment card product entry in column 504.

In an embodiment, the server system 250 may be configured to identify a suitable installment payment option for the user. To identify a suitable installment payment option, the server system 250 may be configured to predict user preferences. For example, the server system 250 may predict that the user may prefer low overall payment or low processing fees. Alternatively, the server system 250 may predict that the user may prefer maximum installment tenure. The prediction may be performed based on the user's past behavior or based on the location or demographic associated with the user. Accordingly, using the predicted user preference and the estimate of transaction value as a reference (for account ranges), as an example, entries in row 530 and 540 (shown as dotted blocks in FIG. 5) may be identified as suitable installment payment options for the ‘Bank of America®’ and the ‘Chase Platinum®’ payment cards, respectively. Accordingly, the server system 250 may be configured to generate loan configurations for each payment card based on the corresponding installment payment options and the estimate of the transaction value. The generated loan configurations are shown in FIG. 6.

Referring now to FIG. 6, a table 600 is shown for illustrating example loan configurations generated by the server system 250, in accordance with an example embodiment of the present disclosure.

As explained with reference to FIG. 5, the server system is configured to identify suitable installment payment options offered by each payment card specified by the user during the interaction with the conversational agent. Accordingly, an installment payment offer is depicted to be identified for each of the ‘Bank of America®’ and ‘Chase Platinum®’ payment cards associated with the user. For each installment payment offer, the server system 250 may be configured to compute the requisite loan configuration as depicted by entries in table 600. More specifically, table 600 is depicted to include columns 602, 604, 606, 608, 610, 612, 614 and 616 labeled ‘PAYMENT CARD’, ‘MAXIMUM NO. OF INSTALLMENTS’, ‘AMOUNT’, ‘TOTAL’, ‘FEES’, ‘TOTAL AMOUNT’, ‘FIRST INSTALLMENT’, ‘SUBSEQUENT INSTALLMENT’. In addition to the row 618 associated with the labels, rows 620 and 622 correspond to payment cards ‘Chase®’ and ‘Bank of America®’ respectively.

As can be seen from the entries in the columns 604-616 corresponding to the ‘Chase®’ payment card, i.e. row 620, the maximum number of installments that the user can opt for is 8, the transaction amount (probable) is 2242, the fees is zero, the first installment is 313.88 and the total amount is 2511.04. Similarly, the entries in the columns 604-616 corresponding to the ‘Bank of America®’ payment card, i.e. row 622, the maximum number of installments is 24, a fee of 25 USD is applicable, the total amount that the user will pay is 2536.04 and the first installment is 84.53 USD.

From the loan configurations shown in the table 600, it can be understood that if the user prefers no fees or low total amount, then the installment payment option offered by Chase® is the best option available to the user. However, if the user prefers longest term (i.e. maximum number of installments) or low installment amount, then the installment payment option offered by the Bank of America® payment card is the better option for the user.

In at least one example embodiment, the server system 250 may be configured to provision the loan configurations as the most suitable installment payment options to the conversational agent. The conversational agent may then query the user for any preferences, such as low processing fees or no fees, maximum number of installments, low monthly installment amount, etc. In some embodiments, the user may provide an input (also referred to herein as the second input) related to a preference in response to the at least one installment payment option offered by the conversational agent. For example, the user may request lowest overall payment or low installment amount. Based on the user specified preference, the conversational agent may choose an appropriate installment payment option and offer the same to the user. An example selection of an installment payment option based on user preference is explained with reference to the continued interaction between the user and the conversational agent in FIG. 3.

Referring back to FIG. 3, at 322, the conversational agent is depicted to offer the two loan configurations as installment payment options to the user. The conversational agent also asks whether the user prefers a longer payment term or no fees.

At 324, the user is depicted to have provided her preference for longer payment term even if it involves paying fees.

At 326 and 328 the user is depicted to ask queries regarding options available to him, such as for example, which offer would result in the lowest overall payment and the like. At 330, the user is depicted to have provided her final confirmation of the preferred option. The installment payment option offered by Chase Platinum payment card is depicted to have been selected, at 332, for the installment-based payment transaction. The conversational agent may then be configured to provision the confirmation of the selection of the installment payment offer to the server system 250, which may further be configured to store the option in the database.

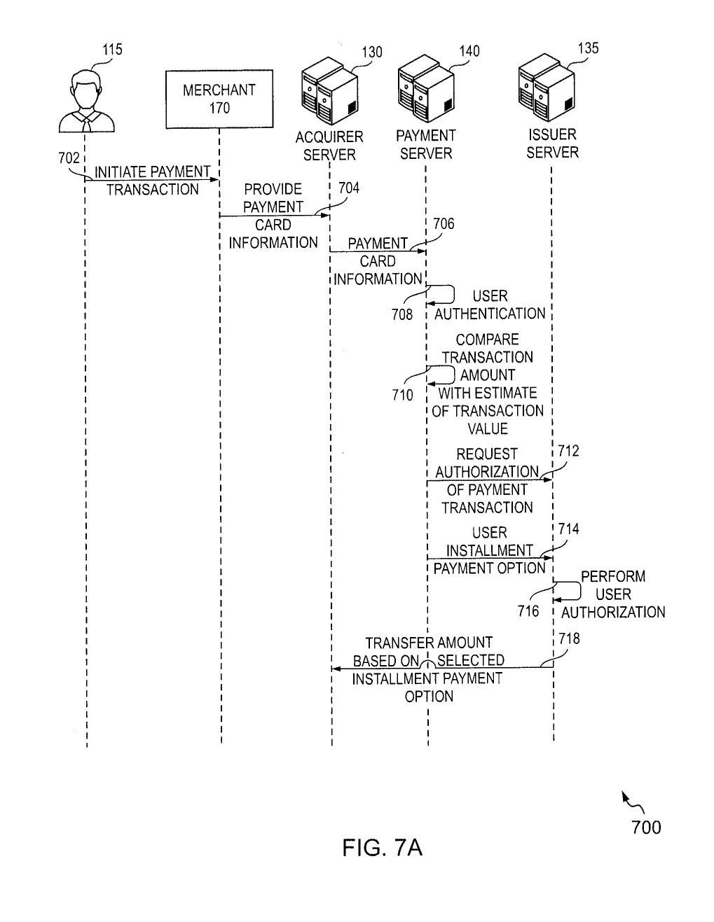

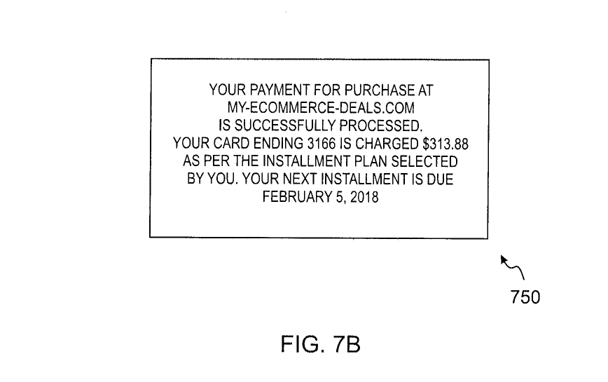

In near future, when the user performs the intended purchase transaction for the refrigerator, either at a retail store or online, the merchant's bank or the acquirer may provision the information to the server system 250 for authentication and processing purposes. The server system 250 may be configured to compare the transaction amount with the stored estimate of the transaction value and if there is a substantial match, then the installment payment option selected by the user may be retrieved from the database and provided to the issuer of the payment card. It is noted that the term ‘substantial match’ as used herein refers to match in numbers within a predefined threshold (for example, +10 USD or −10 USD). For example, if the estimate of the transaction value is 2242 USD as explained with reference to the table 400 in FIG. 4, and if the transaction amount for a purchase at a retail store is 2250 USD, then the two values corresponding to the stored estimate of transaction value and the transaction amount may be deemed to be substantially matching each other. However, if the transaction amount is 1500 USD, then the server system 250 may determine that the two transactions are different and may not retrieve the selected installment payment option for the purchase transaction associated with 1500 USD transaction amount. In at least one example embodiment, the issuer may facilitate processing of the payment transaction based on the installment payment option selected by the user. The processing of the payment transaction is further explained in detail with reference to a sequence flow diagram in FIG. 7A.

FIG. 7A represents a sequence flow diagram 700 for illustrating processing of the payment transaction based on the selected installment payment option, in accordance with an example embodiment of the present disclosure.

As explained with reference to FIG. 2, the user 115 intends to purchase a product using a payment card and seeks assistance from the conversational agent on available installment payment options. The conversational agent extracts information from the conversation with the user 115 and provides the information to the server system 250, which identifies the installment payment options suitable for the user. The conversational agent provides the options to the user and assists the user in selecting the suitable installment payment option. The user selection of the installment payment option is stored along with the estimate of the transaction value in the database 165 by the server system 250. For purposes of this example, the server system 250 corresponds to the payment server 140.

At 702, the user 115 provides payment card information to a merchant 170 to initiate the payment transaction for executing the intended purchase. The payment transaction may be executed using a merchant interface, such as the POS terminal 125 or payment UI associated with the merchant website explained with reference to FIG. 1. More specifically, the payment transaction involves provisioning of a payment card information to the merchant 170 for making the payment in return of the product to be purchased.

At 704, the merchant 170 or more specifically the merchant interface provisions the payment card information to the merchant bank or the acquirer. The acquirer server 130 at the merchant bank is configured to receive the payment card information.

At 706, the acquirer server 130 is configured to provision the payment card information to the payment server 140 for authentication and processing of the payment transaction.

At 708, the payment server 140 is configured to authenticate the user. The payment server 140 may match the payment card details, such as the card number, expiry date, CVV number, and the like, with stored information corresponding to the user. The payment server 140 is further configured to perform authentication an identity of the user using 3D Secure (3DS) or any authentication mechanism, such as one-time password (OTP).

Subsequent to successful authentication, at 710, the payment server 140 compares the transaction amount associated with the payment transaction with the stored estimate of the transaction value. If the stored estimate of the transaction value substantially matches the transaction amount, then the payment server 140 is configured to retrieve the selected installment payment option from the database 165 (shown in FIG. 2).

At 712, the payment server 140 is configured to communicate with the issuer server 135 for authorization of the payment transaction.

At 714, the payment server 140 is also configured to intimate the issuer server 135 of the user authentication and the user selection of the installment payment option.

At 716, the issuer server 135 is configured to check if the user's account is in good standing and has sufficient balance to cover the payment transaction to authorize the payment transaction.

Subsequent to successful authorization, at 718, the issuer server 135 transfers the amount to the acquirer server 130 (i.e. to acquirer account) as per the installment payment option selected by the user. More specifically, only an amount equivalent to the first installment amount is transferred to the merchant account to complete the payment transaction. For example, subsequent to the payment for the purchase of Samsung® refrigerator, the user's payment card may be charged 313.88 USD as per the first installment shown in table 600 in FIG. 6. In some embodiments, a message is provisioned by the issuer server 135 to the user for intimating the user of the successful processing of the payment transaction as per the selected installment payment option. An example message provisioned to the user is shown in FIG. 7B.

FIG. 7B shows a representation of an example message 750 provisioned to the user subsequent to successful processing of the payment transaction as per the user selected installment payment option, in accordance with an example embodiment of the present disclosure.

As explained with reference to FIG. 7A, the payment transaction associated with user's purchase at a merchant location (for example, a physical store location or an online site) is processed based on the user's selection of installment payment option. For example, for a purchase of a Samsung® refrigerator, a first installment amount of 313.88 USD may be charged to user's payment card. The user may be provided a message such as the message 750 stating ‘Your payment for purchase at my-ecommerce-deals.com is successfully processed. Your card ending 3166 is charged $313.88 as per the installment plan selected by you. Your next installment is due Feb. 5, 2018’. The message 750 may be displayed on the display screen of the user's electronic device registered with the payment card issuer. Alternatively, a message similar to the message 750 may be displayed on the merchant interface used for receiving the user's payment card details. The merchant may then intimate the user of the successful processing of the payment transaction as per the installment payment option selected by the user.

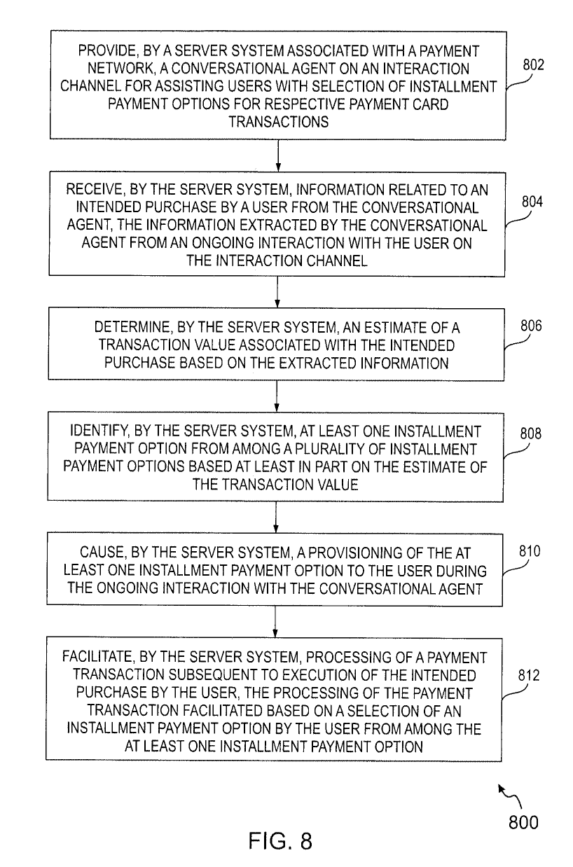

A method for facilitating installment-based payment transaction is explained with reference to FIG. 8.

FIG. 8 illustrates a flow diagram of a method 800 for facilitating installment-based payment transaction, in accordance with an example embodiment. More specifically, a method 800 for facilitating a payment transaction from an issuer account of a user to an acquirer account of a merchant as per a pre-selected installment plan option is disclosed. The method 800 depicted in the flow diagram may be executed by, for example, the at least one server system such as the acquirer server 130, the issuer server 135 and the payment server 140 explained with reference to FIG. 1. Operations of the flow diagram 800, and combinations of operation in the flow diagram 800, may be implemented by, for example, hardware, firmware, a processor, circuitry and/or a different device associated with the execution of software that includes one or more computer program instructions. The operations of the method 800 are described herein with help of the server system associated with a payment network, such as for example the payment server 140. It is noted that the operations of the method 800 can be described and/or practiced by using other server systems, such as the acquirer server 130 and the issuer server 135. The method 800 starts at operation 802.

At 802, the method 800 includes providing, by a server system associated with a payment network (e.g., the payment server 140), a conversational agent on an interaction channel for assisting users with selection of installment payment options for respective payment card transactions. The interaction channel may correspond to a Web interaction channel (i.e. a website), an IVR channel, a chat interaction channel, and the like. In one embodiment, the interaction channel may correspond to a website associated with a payment network entity, such as for example entity configured to facilitate payment card transactions. In another embodiment, the website may correspond to a website of an issuer of a payment card associated with the user. In yet another embodiment, the website may correspond to a merchant website offering products, services and/or information for sale to prospective users.

The conversational agent is configured to engage in an interaction, for example a chat interaction, with the user on the interaction channel to assist the user in selecting an appropriate installment payment option for a purchase that the user intends to engage in, in near future.

At 804, the method 800 includes receiving, by the server system, information related to an intended purchase by a user from the conversational agent. The information is extracted by the conversational agent from an ongoing interaction with the user on the interaction channel. In one embodiment, the conversational agent is configured to interact with the user and use natural language processing and artificial intelligence logic to extract information, such as a type of a product to be purchased, a brand name and brand model associated with the product to be purchased, a location associated with the intended purchase and one or more payment cards capable of being used by the user for the intended purchase. The conversational agent is configured to provide the information to the server system associated with the payment network.

At 806, the method 800 includes determining, by the server system, an estimate of a transaction value associated with the intended purchase based on the extracted information. In one embodiment, the server system is configured to determine an estimate of a transaction value associated with the intended purchase based on the extracted information. To that effect, in one embodiment, the server is configured to retrieve sale offer values for the product to be purchased from one or more merchants in the location associated with the intended purchase. For example, if the user intends to purchase a phone model ‘X’ offered by brand ‘Y’, then the server system may retrieve all sale offer values for such a model being offered by various merchants in the state or the city the user intends to make the purchase. In one embodiment, the server system may be configured to select the highest sale offer from among the sale offer values as the estimate of the transaction value for the intended purchase.

At 808, the method 800 includes identifying, by the server system, at least one installment payment option from among a plurality of installment payment options based at least in part on the estimate of the transaction value. The server system is configured to retrieve installment payment options offered by issuers of one or more payment cards that the user may use for the intended purchase. In one embodiment, the server system may be configured to retrieve account ranges for the various payment cards associated with the user. Further, different installment payment options available for the given estimate of transaction value may be retrieved and at least one installment loan option may be identified to be relevant to the user based on the estimate of the transaction value and predicted user preference. The predicted user preference may correspond to at least one of a preference for low annual percentage rate (APR), a preference for maximum installment tenure, a preference for low overall payment and a preference for low processing fees.

At 810, the method 800 includes causing, by the server system, a provisioning of the at least one installment payment option to the user during the ongoing interaction with the conversational agent. More specifically, the server system may be configured to provision the installment payment options to the conversational agent, who may then relay the installment payment options to the user during the ongoing interaction.

An installment payment option may be selected from among the offered installment payment options either directly by the user or through stating a preference. Subsequent to the selection and/or confirmation of the installment payment option, in one example embodiment, the server system is configured to store the estimate of the transaction value and the installment payment option.

At 812, the method 800 includes facilitating, by the server system, processing of a payment transaction subsequent to execution of the intended purchase by the user. The processing of the payment transaction is facilitated based on a selection of an installment payment option by the user from among the at least one installment payment option.

Subsequently, when the user executes the intended purchase for example at a POS terminal or as an online transaction, the acquirer account (i.e. the merchant banking account) associated with the merchant is configured to provide the payment transaction to the server system for processing the payment transaction. The server system is configured to authenticate the user from the information associated with the payment transaction and subsequent to successful authentication, compare the transaction amount with the estimate of the transaction value. If the transaction amount substantially matches the estimate of the transaction value, then the server system is configured to facilitate processing of the payment transaction. More specifically, the server system is configured to intimate the issuer of the payment card (i.e. the payment card used by the user for the purchase) of the selection of the installment payment option. The issuer may then process the payment transaction as per the installment payment option selected by the user. In some embodiments, a message may be provisioned to the acquirer account and/or the user indicating the successful processing of the payment transaction as per the user selected installment payment option.

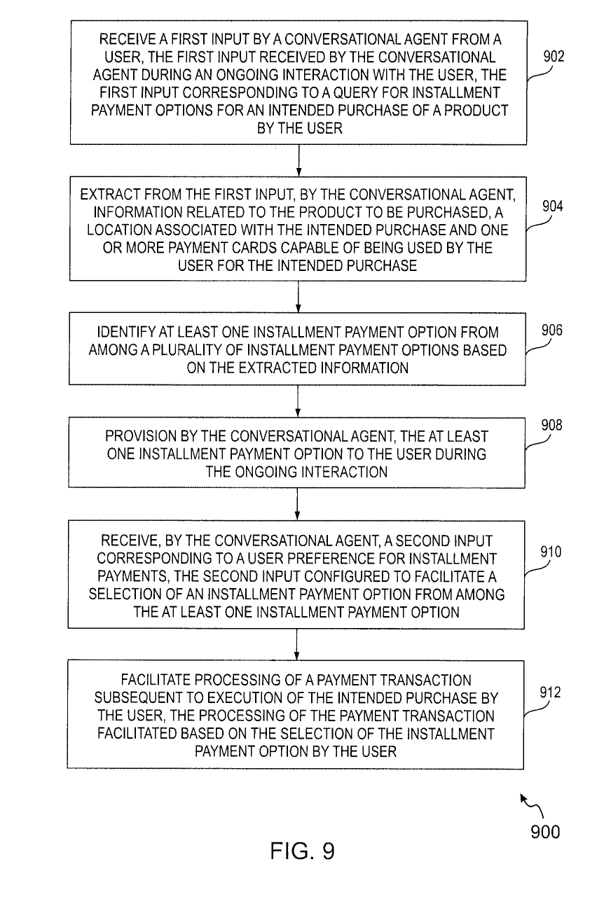

FIG. 9 illustrates a flow diagram of a method 900 for facilitating installment-based payment transaction, in accordance with another example embodiment of the present disclosure. The method 900 depicted in the flow diagram may be executed by, for example, the at least one server system such as the acquirer server 130, the issuer server 135 and the payment server 140 explained with reference to FIG. 1. Operations of the flow diagram 900, and combinations of operation in the flow diagram 900, may be implemented by, for example, hardware, firmware, a processor, circuitry and/or a different device associated with the execution of software that includes one or more computer program instructions. The method 900 starts at operation 902.

At 902, the method 900 includes receiving a first input by a conversational agent from a user. As explained with reference to FIG. 8, the conversational agent is configured to engage in an interaction, for example a chat interaction, with the user on the interaction channel to assist the user in selecting an appropriate installment payment option for a purchase that the user intends to engage in, in near future.

The first input is received by the conversational agent during an ongoing interaction with the user. An example first input received by the conversational agent during the ongoing interaction with the user is shown using 304 and 308 in FIG. 1. The first input corresponds to a query for installment payment options for an intended purchase of a product by the user.

At 904, the method 900 includes extracting from the first input, by the conversational agent, information related to the product to be purchased, a location associated with the intended purchase and one or more payment cards capable of being used by the user for the intended purchase. In one embodiment, the conversational agent is configured to interact with the user and use natural language processing and artificial intelligence logic to extract information related to the intended purchase.

At 906, the method 900 includes identifying at least one installment payment option from among a plurality of installment payment options based on the extracted information. The identification of at least one installment payment option may be performed as explained with reference to 806 and 808 in FIG. 8 and is not explained again herein.

At 908, the method 900 includes provisioning at least one installment payment option by the conversational agent to the user during the ongoing interaction. An example provisioning of the at least one installment payment option is shown using 322 in FIG. 3.

At 910, the method 900 includes receiving, by the conversational agent, a second input corresponding to a user preference for installment payments. The user preference may correspond to at least one of a preference for low annual percentage rate (APR), a preference for maximum installment tenure, a preference for low overall payment and a preference for low processing fees. An example second input provided to the conversational agent by the user is shown using 328 in FIG. 3. The second input is configured to facilitate a selection of an installment payment option from among the at least one installment payment option.

At 912, the method 900 includes facilitating processing of a payment transaction subsequent to execution of the intended purchase by the user. The processing of the payment transaction is facilitated based on the selection of the installment payment option by the user. The facilitation of payment transaction processing may be performed as explained with reference to 812 in FIG. 8 and is not explained again herein.

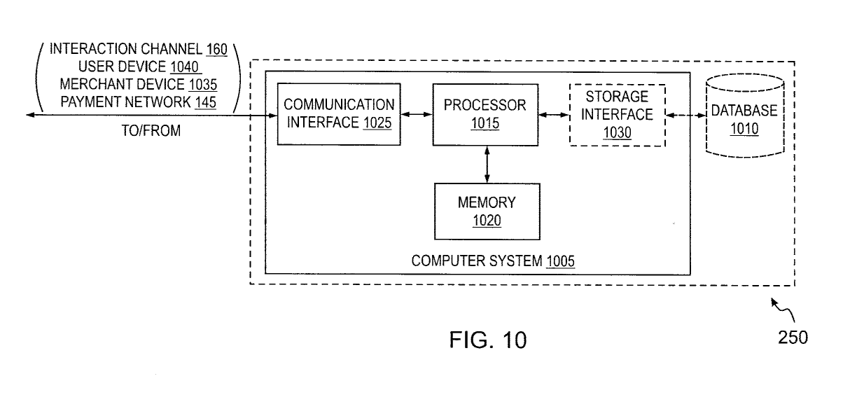

FIG. 10 is a simplified block diagram of a server system 250 used for facilitating installment-based payment transactions, in accordance with an example embodiment of the present disclosure. The server system 250 is an example of a server system that is a part of the payment network 145. Examples of the server system 250 includes, but not limited to, the acquirer server 130, the issuer server 135 and the payment server 140. The server system 250 includes a computer system 1005 and a database 1010 (such as the database 165 explained with reference to FIG. 2).

The computer system 1005 includes at least one processor 1015 for executing instructions. Instructions may be stored in, for example, but not limited to, a memory 1020. The processor 1015 may include one or more processing units (e.g., in a multi-core configuration).

The processor 1015 is operatively coupled to a communication interface 1025 such that the computer system 1005 is capable of communicating with a remote device such as a server associated with the interaction channel 160, a merchant device 1035 (e.g., the POS terminal 125), a user device 1040 (e.g., the user device 155 shown in FIG. 2) or communicating with any entity within the payment network 145. For example, the communication interface 1025 may receive the information extracted by the conversational agent and/or payment transaction request including a transaction amount from the merchant device 1035, via the Internet.

The processor 1015 may also be operatively coupled to the database 1010. The database 1010 is any computer-operated hardware suitable for storing and/or retrieving data, such as, but not limited to, transaction data generated as part of sales activities conducted over the bankcard network including data relating to merchants, account holders or customers, and purchases. The database 1010 may also store information related to a plurality of user's payment accounts. Each user account data includes at least one of a user name, a user address, an account number, PIN, and other account identifiers. The database 1010 may also store merchant data including a merchant identifier that identifies each merchant registered to use the payment network, and instructions for settling transactions including merchant bank account information (e.g., a plurality of payment accounts related to POS terminals associated with merchants).

The database 1010 further includes information related to sale offer values for products being offered for sale by various merchants in a variety of locations. The database 1010 may also include information related to applicable taxes in the corresponding locations. Furthermore, the database 1010 may include information related to payment card products offered by various issuing institutions and the installment payment options associated with the respective products. It is noted that the sale offer values for products and/or card product installment offers may be updated at regular intervals to provide the latest information to the user as needed.

The database 1010 is also configured to store the estimate of the transaction value and the user selection of installment payment option in conjunction with the user's payment card information to facilitate installment-based payment transactions as explained with reference to FIGS. 2 to 9.

The database 1010 may include multiple storage units such as hard disks and/or solid-state disks in a redundant array of inexpensive disks (RAID) configuration. The database 1010 may include a storage area network (SAN) and/or a network attached storage (NAS) system. In some embodiments, the database 1010 is integrated within the computer system 1005. For example, the computer system 1005 may include one or more hard disk drives as the database 1010. In other embodiments, the database 1010 is external to the computer system 1005 and may be accessed by the computer system 1005 using a storage interface 1030. The storage interface 1030 is any component capable of providing the processor 1015 with access to the database 1010. The storage interface 1030 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1015 with access to the database 1010.

The processor 1015 is configured to determine the estimate of the transaction value for the intended purchase of the user based on the information received from the conversational agent. The processor 1015 is further configured to identify the installment payment options relevant to the user from among a plurality of installment payment options. Further, the processor 1015 is configured to compare the transaction amount of an executed purchase by the user with the stored estimate of transaction value to determine if the installment payment option selected by the user is to be applied to the current payment transaction or not. Thereafter, the processor 1015 is configured to complete the payment transaction of the transaction amount from issuer account to the acquirer account. In some embodiments, the processor 1015 is also configured to notify the user device 1040 and the merchant device 1035 of the transaction status via the communication interface 1025.

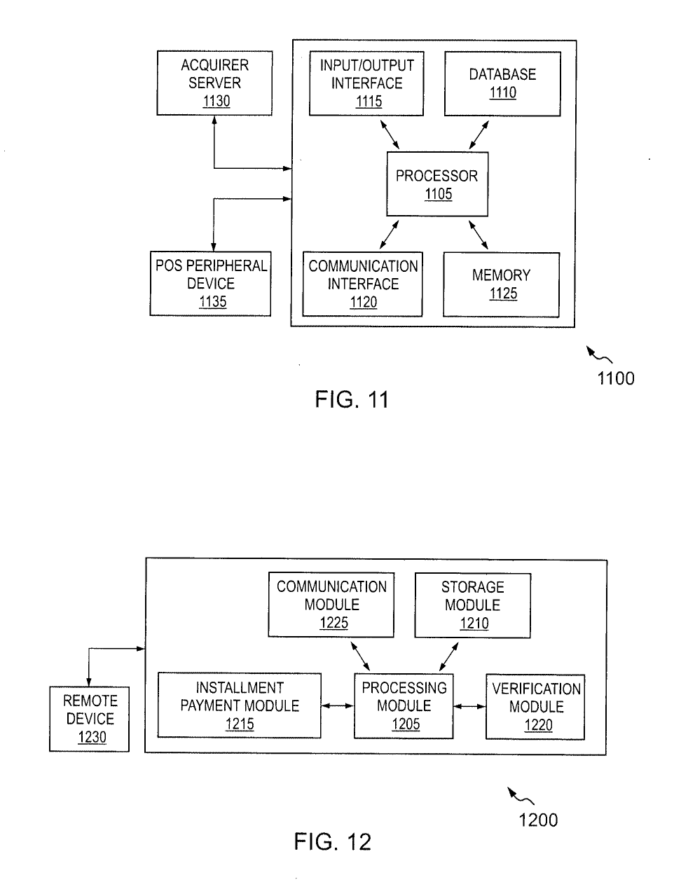

FIG. 11 is a simplified block diagram of a POS terminal 1100 used for payment transaction, in accordance with an example embodiment of the present disclosure. The POS terminal 1100 as explained herein is only one example of the merchant device 1035. In various embodiments, the merchant device 1035 can be a merchant mobile phone, a kiosk, a PDA, a merchant facilitated e-commerce website interface running on a computing device and the like. The POS terminal 1100 is an example of the POS terminal 125 of FIG. 1 in terms of functionalities and features. The POS terminal 1100 includes at least one processor 1105 communicably coupled to a database 1110, an Input/Output (I/O) interface 1115, a communication interface 1120 and a memory 1125. The components of the POS terminal 1100 provided herein may not be exhaustive, and that the POS terminal 1100 may include more or fewer components than that of depicted in FIG. 11. Further, two or more components may be embodied in one single component, and/or one component may be configured using multiple sub-components to achieve the desired functionalities. Some components of the POS terminal 1100 may be configured using hardware elements, software elements, firmware elements and/or a combination thereof.

The I/O interface 1115 is configured to receive inputs from and provide outputs to the end-user (i.e. the merchant and/or the customer) of the POS terminal 1100. For instance, the I/O interface 1115 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 1125 can be any type of storage accessible to the processor 1105. For example, the memory 1125 may include volatile or non-volatile memories, or a combination thereof. In some non-limiting examples, the memory 1125 can be four to sixty-four Megabytes (MB) of Dynamic Random Access Memory (“DRAM”) or Static Random Access Memory (“SRAM”). In addition, some examples may include supplementary flash memory installed via a PCMCIA slot.

The database 1110 is capable of storing and/or retrieving data, such as, but not limited to, smart card insertions, user/customer information, merchant information, card swipes, touch-screen key depressions, keypad key depressions, number of dots printed by the slip and roll printers, check read errors, and the like. Such information can be accessed by the processor 1105 using the communication interface 1120 to determine potential future failures and the like.

The POS terminal 1100 is capable of communicating with one or more POS peripheral devices such as a POS peripheral device 1135 and external server system such as an acquirer server 1130 (an example of the acquirer server 130 of FIG. 1) via the communication interface 1120 over a communication network such as the network 150 of FIG. 1. The POS peripheral device 1135 can provide functionality which is used by a consumer at a merchant facility, such as PIN entry, clear text entry, signature capture, and the like. Some non-exhaustive examples of the POS peripheral device 1135 include barcode scanner, cash drawer, magnetic stripe reader, receipt printer, PIN pad, signature capture device, touchscreen, keyboard, portable data terminal, card reader, customer pole display and the like. In some embodiments, the POS terminal 1100 may be mounted near a cash register at a check-out counter in merchant facility, while the POS peripheral device 1135 may be mounted on the check-out counter such that it is accessible to the users. In this way, both the merchant and the user/customer can interact with similar devices to process the payment transaction.

The communication interface 1120 is further configured to cause display of user interfaces on the POS terminal 1100. In one embodiment, the communication interface 1120 includes a transceiver for wirelessly communicating information to, or receiving information from, the acquirer server 1130 or other suitable display device, and/or another type of remote processing device. In another embodiment, the communication interface 1120 is capable of facilitating operative communication with the remote devices and a cloud server using Application Program Interface (API) calls. The communication may be achieved over a communication network, such as the network 150.

The processor 1105 is capable of sending the payment transaction request received from the end-user via the communication interface 1120 to the acquirer server 1130 for processing the payment transaction. For example, the processor 1105 is configured to receive the payment card information and the transaction amount entered by the end-user using the UIs. The processor 1105 can access the database 1110 to retrieve the user information and merchant information that are required to be sent along with the payment transaction request to the acquirer server 1130.

Additionally, the POS terminal 1100 can include an operating system and various software applications that can provide various functionality to the POS terminal 1100. For example, in some embodiments, the POS terminal 1100 is addressable with an Internet protocol and includes a browser application. In such embodiments, the processor 1105 includes software adapted to support such functionality. In some embodiments, the processor 1105 executes software to support network management. In particular, this capacity allows software to be downloaded to a plurality of such systems to provide new applications such as application for enabling installment-based payment transactions using POS terminals and/or updates to existing applications. The operating system and software application upgrades are distributed and maintained through communication to the POS terminal 1100 over the communication network 150.

FIG. 12 is a simplified block diagram of an issuer server 1200 for facilitating payment transaction using installment payment option, in accordance with one embodiment of the present disclosure. The issuer server 1200 is an example of the issuer server 135 of FIG. 1, or may be embodied in the issuer server 135. The issuer server 1200 is associated with an issuer bank/issuer, in which a user may have an account, which provides an installment-based electronic payment transaction facility. The issuer server 1200 includes a processing module 1205 operatively coupled to a storage module 1210, an installment payment module 1215, a verification module 1220 and a communication module 1225. The components of the issuer server 1200 provided herein may not be exhaustive, and that the issuer server 1200 may include more or fewer components than that of depicted in FIG. 12. Further, two or more components may be embodied in one single component, and/or one component may be configured using multiple sub-components to achieve the desired functionalities. Some components of the issuer server 1200 may be configured using hardware elements, software elements, firmware elements and/or a combination thereof.

The storage module 1210 is configured to store machine executable instructions to be accessed by the processing module 1205. Additionally, the storage module 1210 stores information related to, contact information of the user, bank account number, BICs, payment card details, internet banking information, PIN, mobile personal identification number (MPIN) for mobile banking and the like. This information is retrieved by the processing module 1205 for cross-verification during payment transactions.

The processing module 1205, in conjunction with the verification module 1220, is configured to verify the PIN (e.g., whether the four-digit numeric code matches the PIN issued by the issuer), the sufficient funds in the issuer account, payment card details and the like. Upon successful verification only, the processing module 1205 in conjunction with the installment payment module 1215 is configured to process the payment transaction by debiting the transaction amount from the issuer account of the user. The processing module 1205 is further configured to communicate with one or more remote devices such as a remote device 1230 using the communication module 1225 over a network such as the network 150 or the payment network 145 of FIG. 1. The examples of the remote device 1230 include, the merchant device 1035, the user device 1040, the payment server 140, the acquirer server 130, other computing systems of issuer and the payment network 145 and the like. The communication module 1225 is capable of facilitating such operative communication with the remote devices and cloud servers using API (Application Program Interface) calls.

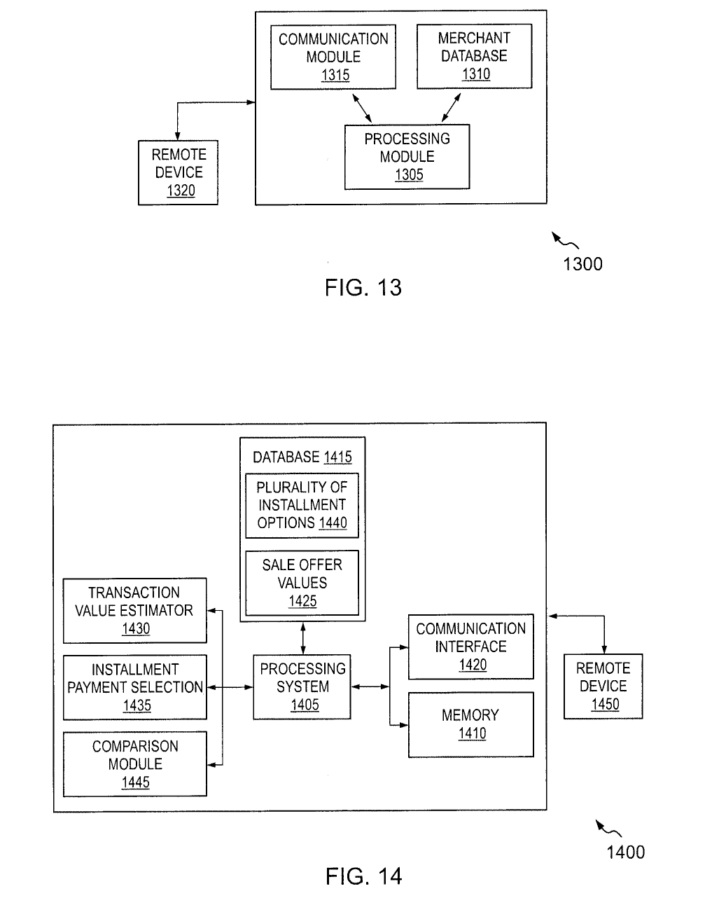

FIG. 13 is a simplified block diagram of an acquirer server 1300 used for payment transaction using installment payment option, in accordance with one embodiment of the present disclosure. The acquirer server 1300 is associated with the acquirer bank of a merchant where the merchant has established an account to accept payment using installment payment options. The acquirer server 1300 is an example of the acquirer server 130 of FIG. 1, or may be embodied in the acquirer server 130. Further, the acquirer server 1300 is configured to facilitate installment payment with the issuer server 1200 using the payment network 145 of FIG. 1. The acquirer server 1300 includes a processing module 1305 communicably coupled to a merchant database 1310 and a communication module 1315. The components of the acquirer server 1300 provided herein may not be exhaustive, and that the acquirer server 1300 may include more or fewer components than that of depicted in FIG. 13. Further, two or more components may be embodied in one single component, and/or one component may be configured using multiple sub-components to achieve the desired functionalities. Some components of the acquirer server 1300 may be configured using hardware elements, software elements, firmware elements and/or a combination thereof.

The merchant database 1310 includes data related to merchant, such as, but not limited to, a merchant primary account number (PAN), a merchant name, a merchant category code (MCC), a merchant city, a merchant postal code, a merchant brand name, a merchant ID and the like. The processing module 1305 is configured to use the merchant ID to identify the merchant during the normal processing of payment transactions, adjustments, chargebacks, end-of-month fees and so forth. The merchant ID is different than other merchant account numbers, particularly those that identify merchants to the equipment (e.g., the POS terminals or any other merchant electronic devices) they use for processing transactions. A merchant with a single merchant processing account number may use several terminals at one location, resulting in one merchant ID and several terminal identification numbers (TIDs). The processing module 1305 may be configured to store and update such merchant information in the merchant database 1310 for later retrieval.

In an embodiment, the communication module 1315 is capable of facilitating operative communication with a remote device 1320 (e.g., the POS terminal 1100, the issuer server 1200, the merchant device 1035 and/or the payment server 140) using API calls. The communication may be achieved over a communication network, such as the network 150. For example, the processing module 1305 may receive the payment card information and the transaction amount from the POS terminal 1100 using the communication module 1315. Further, the processing module 1305 is configured to receive the debited transaction amount from the payment server 140 or the issuer server 135 (or the issuer server 1200) using the communication module 1315. Thereafter, the processing module 1305 may retrieve merchant PAN from the merchant database 1310 to credit the transaction amount in the acquirer account of the merchant. Further, the processing module 1305 may be configured to send the transaction status to the POS terminal 1100 of the merchant.

FIG. 14 is a simplified block diagram of a payment server 1400 used for facilitating payment transaction using installment payment option, in accordance with one embodiment of the present disclosure. The payment server 1400 may correspond to payment server 140 of FIG. 1. As explained with reference to FIG. 1, the payment server 140 is associated with a payment network 145. The payment network 145 may be used by the issuer server 1200 and the acquirer server 1300 as a payment interchange network. Examples of payment interchange network include, but not limited to, Mastercard® payment system interchange network. The payment server 1400 includes a processing system 1405 configured to extract programming instructions from a memory 1410 to provide various features of the present disclosure. The components of the payment server 1400 provided herein may not be exhaustive, and that the payment server 1400 may include more or fewer components than that of depicted in FIG. 14. Further, two or more components may be embodied in one single component, and/or one component may be configured using multiple sub-components to achieve the desired functionalities. Some components of the payment server 1400 may be configured using hardware elements, software elements, firmware elements and/or a combination thereof.

Via a communication interface 1420, the processing system 1405 receives information related to the intended purchase extracted by the conversational agent. A transaction value estimator 1430 is operatively coupled to the processing system 1405. The transaction value estimator 1430 is configured to retrieve sale offer values 1425 stored in a database 1415 and determine an estimate of transaction value. The determination of the estimate of transaction value may be performed as explained with reference to FIG. 4 and is not explained herein. An installment payment selection module 1435 is operatively coupled to the processing system 1405. The installment payment selection module 1435 is configured to retrieve a plurality of installment options 1440 offered by various issuers of payment cards from the database 1415. The installment payment selection module 1435 is further configured to identify relevant installment payment options for the user based on the estimate of transaction value and predicted user preference. The relevant installment payment options are provisioned to the user device (an example a remote device 1450) using the communication interface 1420.

In an embodiment, the remote device 1450 may correspond to the acquirer server 1300. The remote device 1450 may provide payment card information and a transaction amount associated with an executed purchase to the communication interface 1420. A comparison module 1445 is depicted to be operatively coupled to the processing system 1405. The processing system 1405 may facilitate user authentication. Subsequent to successful user authentication, the comparison module 1445 may be configured to compare the transaction amount with the estimate of transaction value and if the transaction amount substantially matches the estimate of transaction value, then the installment payment option selected by the user may be retrieved from the database 1415 and provided to the issuer server 1200 (an example remote device 1450) to facilitate processing of the payment transaction.

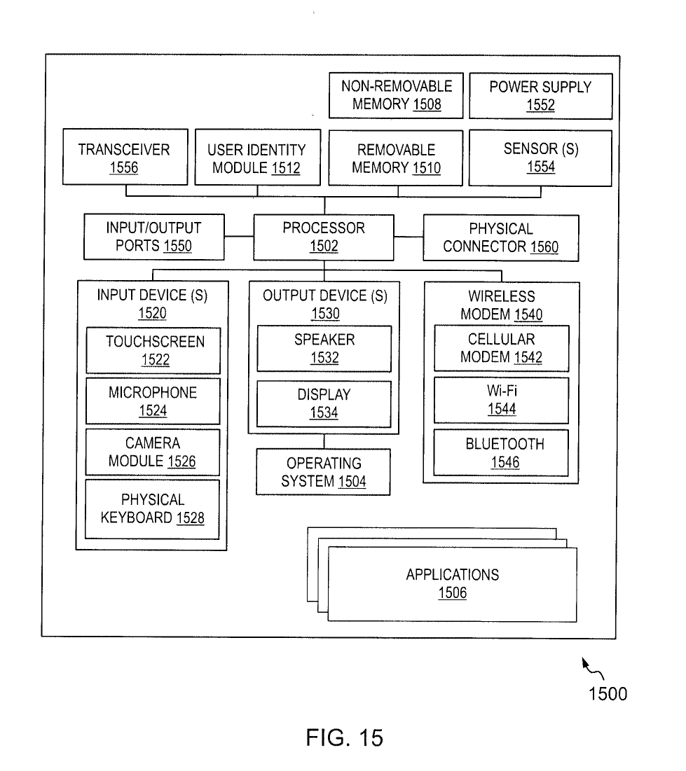

FIG. 15 shows simplified block diagram of a user device 1500 for example a mobile phone or a desktop computer capable of implementing the various embodiments of the present disclosure. For example, the user device 1500 may correspond to the user device 1040 of FIG. 10. The user device 1500 is depicted to include one or more applications 1506.

It should be understood that the user device 1500 as illustrated and hereinafter described is merely illustrative of one type of device and should not be taken to limit the scope of the embodiments. As such, it should be appreciated that at least some of the components described below in connection with that the user device 1500 may be optional and thus in an example embodiment may include more, less or different components than those described in connection with the example embodiment of the FIG. 15. As such, among other examples, the user device 1500 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1500 includes a controller or a processor 1502 (e.g., a signal processor, microprocessor, ASIC, or other control and processing logic circuitry) for performing such tasks as signal coding, data processing, image processing, input/output processing, power control, and/or other functions. An operating system 1504 controls the allocation and usage of the components of the user device 1500 and support for one or more payment transaction applications programs (see, applications 1506), that implements one or more of the innovative features described herein. In addition, the applications 1506 may include common mobile computing applications (e.g., telephony applications, email applications, calendars, contact managers, web browsers, messaging applications) or any other computing application.

The illustrated user device 1500 includes one or more memory components, for example, a non-removable memory 1508 and/or a removable memory 1510. The non-removable memory 1508 and/or the removable memory 1510 may be collectively known as database in an embodiment. The non-removable memory 1508 can include RAM, ROM, flash memory, a hard disk, or other well-known memory storage technologies. The removable memory 1510 can include flash memory, smart cards, or a Subscriber Identity Module (SIM). The one or more memory components can be used for storing data and/or code for running the operating system 1504 and the applications 1506. The user device 1500 may further include a user identity module (UIM) 1512. The UIM 1512 may be a memory device having a processor built in. The UIM 1512 may include, for example, a subscriber identity module (SIM), a universal integrated circuit card (UICC), a universal subscriber identity module (USIM), a removable user identity module (R-UIM), or any other smart card. The UIM 1512 typically stores information elements related to a mobile subscriber. The UIM 1512 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1500 can support one or more input devices 1520 and one or more output devices 1530. Examples of the input devices 1520 may include, but are not limited to, a touch screen/a display screen 1522 (e.g., capable of capturing finger tap inputs, finger gesture inputs, multi-finger tap inputs, multi-finger gesture inputs, or keystroke inputs from a virtual keyboard or keypad), a microphone 1524 (e.g., capable of capturing voice input), a camera module 1526 (e.g., capable of capturing still picture images and/or video images) and a physical keyboard 1528. Examples of the output devices 1530 may include, but are not limited to a speaker 1532 and a display 1534. Other possible output devices can include piezoelectric or other haptic output devices. Some devices can serve more than one input/output function. For example, the touch screen 1522 and the display 1534 can be combined into a single input/output device.

A wireless modem 1540 can be coupled to one or more antennas (not shown in the FIG. 15) and can support two-way communications between the processor 1502 and external devices, as is well understood in the art. The wireless modem 1540 is shown generically and can include, for example, a cellular modem 1542 for communicating at long range with the mobile communication network, a Wi-Fi compatible modem 1544 for communicating at short range with an external Bluetooth-equipped device or a local wireless data network or router, and/or a Bluetooth-compatible modem 1546. The wireless modem 1540 is typically configured for communication with one or more cellular networks, such as a GSM network for data and voice communications within a single cellular network, between cellular networks, or between the user device 1500 and a public switched telephone network (PSTN).

The user device 1500 can further include one or more input/output ports 1550, a power supply 1552, one or more sensors 1554 for example, an accelerometer, a gyroscope, a compass, or an infrared proximity sensor for detecting the orientation or motion of the user device 1500 and biometric sensors for scanning biometric identity of an authorized user, a transceiver 1556 (for wirelessly transmitting analog or digital signals) and/or a physical connector 1560, which can be a USB port, IEEE 1294 (FireWire) port, and/or RS-232 port. The illustrated components are not required or all-inclusive, as any of the components shown can be deleted and other components can be added.

The disclosed methods with reference to FIGS. 2 and 7B, or one or more operations of the flow diagrams 800 and 900 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server systems 250 its various components such as the computer system 1005 and the database 1010 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving a first input by a conversational agent from a user, the first input received by the conversational agent during an ongoing interaction with the user, the first input corresponding to a query for installment payment options for an intended purchase of a product by the user;
extracting from the first input, by the conversational agent, information related to the product to be purchased, a location associated with the intended purchase and one or more payment cards capable of being used by the user for the intended purchase;
identifying at least one installment payment option from among a plurality of installment payment options based on the extracted information;
provisioning, by the conversational agent, the at least one installment payment option to the user during the ongoing interaction;
receiving, by the conversational agent, a second input corresponding to a user preference for installment payments, the second input configured to facilitate a selection of an installment payment option from among the at least one installment payment option; and
facilitating processing of a payment transaction subsequent to execution of the intended purchase by the user, the processing of the payment transaction facilitated based on the selection of the installment payment option by the user.

2. The method as claimed in claim 1, wherein the conversational agent is configured to use natural language processing and artificial intelligence logic to extract the information from the first input.

3. The method as claimed in claim 1, further comprising:
determining an estimate of a transaction value associated with the intended purchase based on the extracted information, wherein the at least one installment payment option is identified based at least in part on the estimate of the transaction value.

4. The method as claimed in claim 3, further comprising:
retrieving sale offer values for the product to be purchased from one or more merchants in the location associated with the intended purchase, wherein a highest sale offer value from among the retrieved sale offer values is selected as the estimate of the transaction value.

5. The method as claimed in claim 3, further comprising:
retrieving the plurality of installment payment options offered by issuers of the one or more payment cards associated with the user, wherein the at least one installment payment option from among the plurality of installment payment options is identified to be relevant to the user based on the estimate of the transaction value and the second input.

6. The method as claimed in claim 5, further comprising:
storing the estimate of the transaction value and the selected installment payment option;
receiving the payment transaction from an acquirer account for processing, the payment transaction comprising a transaction amount associated with the intended purchase executed by the user;
authenticating the user based on information associated with the payment transaction;
subsequent to successful authentication, comparing the transaction amount of the payment transaction with the stored estimate of the transaction value; and
if the transaction amount substantially matches the estimate of the transaction value, retrieving the stored selection of the installment payment option corresponding to the estimate of the transaction value,
wherein processing of the payment transaction between an issuer account associated with a payment card of the user and the acquirer account is facilitated based on the stored selection of the installment payment option.

7. The method as claimed in claim 1, wherein the user preference corresponds to a preference for low annual percentage rate (APR), and wherein an installment payment option associated with the lowest APR from among the at least one installment payment option is selected as the installment payment option to be used for processing of the payment transaction associated with the intended purchase by the user.

8. The method as claimed in claim 1, wherein the user preference corresponds to a preference for long-term installment plan, and wherein an installment payment option offering a maximum installment tenure from among the at least one installment payment option is selected as the installment payment option to be used for processing of the payment transaction associated with the intended purchase by the user.

9. The method as claimed in claim 1, wherein the user preference corresponds to a preference for low overall payment, and wherein an installment payment option associated with the lowest overall payment from among the at least one installment payment option is selected as the installment payment option to be used for processing of the payment transaction associated with the intended purchase by the user.

10. The method as claimed in claim 1, wherein the user preference corresponds to a preference for low processing fees, and wherein an installment payment option associated with the lowest processing fees from among the at least one installment payment option is selected as the installment payment option to be used for processing of the payment transaction associated with the intended purchase by the user.

11. A server system in a payment network, comprising:
a memory comprising stored instructions; and
at least one processor, configured to execute the stored instructions to cause the server system to perform at least:
providing a conversational agent on an interaction channel for assisting users with selection of installment payment options for respective payment card transactions;
receiving information related to an intended purchase by a user from the conversational agent, the information extracted by the conversational agent from an ongoing interaction with the user on the interaction channel;
determining an estimate of a transaction value associated with the intended purchase based on the extracted information;
identifying at least one installment payment option from among a plurality of installment payment options based at least in part on the estimate of the transaction value;
causing a provisioning of the at least one installment payment option to the user during the ongoing interaction with the conversational agent; and
facilitating processing of a payment transaction subsequent to execution of the intended purchase by the user, the processing of the payment transaction facilitated based on a selection of an installment payment option by the user from among the at least one installment payment option.

12. The server system as claimed in claim 11, wherein the conversational agent is configured to use natural language processing and artificial intelligence logic to extract the information from the ongoing interaction with the user.

13. The server system as claimed in claim 11, wherein the extracted information related to the intended purchase comprises information related to at least one of a type of a product to be purchased, a brand name and a brand model associated with the product to be purchased, a location associated with the intended purchase and one or more payment cards capable of being used by the user for the intended purchase.

14. The server system as claimed in claim 13, wherein for identifying the at least one installment payment option, the server system is further caused to perform at least:
retrieving the plurality of installment payment options offered by issuers of the one or more payment cards associated with the user, wherein the at least one installment payment option from among the plurality of installment payment options is identified to be relevant to the user based on the estimate of the transaction value and predicted user preference.

15. The server system as claimed in claim 13, wherein for identifying the at least one installment payment option, the server system is further caused to perform at least:
storing the estimate of the transaction value and the selected installment payment option; and
comparing a transaction amount of the payment transaction with the stored estimate of the transaction value,
wherein processing of the payment transaction based on the selected installment payment option is facilitated if the transaction amount substantially matches the stored estimate of the transaction value.

16. The server system as claimed in claim 11, wherein for determining the estimate of the transaction value associated with the intended purchase, the server system is further caused to perform:
retrieving sale offer values for a product to be purchased from one or more merchants in a location associated with the intended purchase, wherein a sale offer value from among the retrieved sale offer values is selected as the estimate of the transaction value.

17. The server system as claimed in claim 16, wherein a highest sale offer value from among the retrieved sale offer values is selected as the estimate of the transaction value.

18. A computer-implemented method comprising:
receiving, by a server system, a payment transaction from an acquirer account for processing, the payment transaction comprising a transaction amount associated with a purchase executed by a user;
authenticating, by the server system, the user based on information associated with the payment transaction;
subsequent to successful authentication, comparing, by the server system, the transaction amount of the payment transaction with a stored estimate of a transaction value;
if the transaction amount substantially matches the estimate of the transaction value, retrieving by the server system a stored selection of an installment payment option corresponding to the estimate of the transaction value; and
facilitating, by the server system, processing of the payment transaction between an issuer account associated with a payment card of the user and the acquirer account based on the stored selection of the installment payment option.

19. The method as claimed in claim 18, further comprising:
providing, by the server system, a conversational agent on an interaction channel associated with the acquirer account for assisting users with selection of installment payment options for respective payment card transactions;
receiving, by the server system, information related to an intended purchase by the user from the conversational agent, wherein the intended purchase corresponds to the purchase prior to its execution, and wherein the information extracted by the conversational agent from an ongoing interaction with the user on the interaction channel, wherein the extracted information comprises information related to at least one of a type of a product to be purchased, a brand name and a brand model associated with the product to be purchased, a location associated with the intended purchase and one or more payment cards capable of being used by the user for the purchase; and
determining, by the server system, the estimate of the transaction value associated with the intended purchase based on the extracted information.

20. The method as claimed in claim 19, further comprising:
retrieving, by the server system, sale offer values for the product to be purchased from one or more merchants in the location associated with the intended purchase, wherein a sale offer value from among the retrieved sale offer values is selected as the estimate of the transaction value; and
retrieving a plurality of installment payment options offered by issuers of the one or more payment cards associated with the user, wherein at least one installment payment option from among the plurality of installment payment options is identified to be relevant to the user based on the estimate of the transaction value and predicted user preference.
